(19) United States
(12) Patent Application Publication
(10) Pub. No.: US 2023/0323888 A1
(43) Pub. Date: Oct. 12, 2023

(54) A PUMP AND A SET OF SEALS SEALING THE STATOR COMPONENTS OF SUCH A PUMP

(71) Applicant: Edwards Limited, Burgess Hill, West Sussex (GB)

(72) Inventor: Alan Ernest Kinnaird Holbrook, Burgess Hill, Sussex (GB)

(21) Appl. No.: 17/796,512

(22) PCT Filed: Jan. 25, 2021
(86) PCT No.: PCT/GB2021/050163

§ 371 Date: Jul. 29, 2022

(30) Foreign Application Priority Data
Jan. 30, 2020 (GB) 2001318.1

(51) Int. Cl. F04D 29/08; F04D 19/04

(52) U.S. Cl. CPC F04D 29/083; F04D 19/04; F16J 15/022

(57) ABSTRACT

A set of seals for sealing between two half shells defining at least one pumping chamber and two head plates to be mounted at either end of the two half shells. The set of seals includes: at least one annular seal for sealing between at least one of the head plates and the two half shells; two longitudinal seals for sealing between longitudinal contact faces of the two half shell stators on either side of the at least one pumping chamber, the longitudinal seals being configured to have end portions that abut against the at least one annular seal when mounted in the pump. Each of the seals within the set of seals are made of a material having at least one of: a hardness between 73-83, on the Shore A hardness scale; and a stiffness of between 2.4 and 4.2 N/mm per mm length.

### CROSS-REFERENCE TO RELATED APPLICATION

This application is a Section 371 National Stage Application of International Application No. PCT/GB2021/050163, filed Jan. 25, 2021, and published as WO 2021/152294A1 on Aug. 5, 2021, the content of which is hereby incorporated by reference in its entirety and which claims priority of British Application No. 2001318.1, filed Jan. 30 2020.

### FIELD

The field of the invention relates to a set of seals for sealing between different stator components of a pump and to a pump comprising such seals.

### BACKGROUND

The mounting of a rotor within a stator of some pump assemblies is made simpler by the use of half or clam shell stators. This allows the rotor to be placed within one half shell and the other half shell to be fitted on top. Head plates or end pieces are then used at either end of the stator to support bearings and drive systems. A seal is required between the stator half shells and between the end pieces and stator.

The split line between the stators reaches the seal that seals between the head plates and stator at a so-called T-joint. These T-joints are sealed with a combination of axial and annular seals, which are compressed. The complex geometry of the T-seal causes the seals to distort when compressed. The main challenge is to keep the seals in contact with the housings and in contact with each other across a range of operational temperatures. This is a challenging problem made increasingly difficult as the range of temperatures of pump operation increases.

It would be desirable to provide a set of seals for sealing the stator components of a half shell stator that provides effective sealing across a range of operational temperatures.

The discussion above is merely provided for general background information and is not intended to be used as an aid in determining the scope of the claimed subject matter. The claimed subject matter is not limited to implementations that solve any or all disadvantages noted in the background.

### SUMMARY

A first aspect provides a set of seals for sealing between the stator components of a pump, said stator components comprising two half shells defining at least one pumping chamber and two head plates to be mounted at either end of said two half shells, said set of seals comprising: at least one annular seal for sealing between at least one of said head plates and said two half shells; two longitudinal seals for sealing between longitudinal contact faces of said two half shell stators on either side of said at least one pumping chamber, said longitudinal seals being configured to have end portions that abut against said at least one annular seal when mounted in said pump; wherein each of said seals within said set of seals are made of a material having at least one of: a hardness between 73-83, preferably 75-81 on the Shore A hardness scale; and a stiffness of between 2.4 and 4.2 N/mm per mm length, wherein said stiffness is measured by axially compressing at room temperature an O-ring of said material, said O-ring having a cross section diameter of 3.4 mm and an internal diameter of at least 40 mm.

The inventor of the present invention recognised that as the temperature range of operation of half shell stator pumps increases there is a requirement to look for new materials for the seals, which materials should be able to withstand larger temperature ranges and in particular, higher temperatures without becoming unduly degraded.

In embodiments it is possible that there could be at least one longitudinal seal for sealing between longitudinal contact faces of said two half shell stators on at least one side of said at least one pumping chamber.

Selecting new materials for seals with the challenging requirements of a T-joint is a complex matter, however, the inventor of the present invention discovered that the properties of stiffness and/or hardness were particularly good predictors of a good sealing material for such T-joint seals, and indeed were seals to be formed of a material with stiffness and/or hardness within a particular range such seals would generally seal effectively.

It has been found that variations in the compression applied to each seal cause corresponding changes in their internal stresses and in their distortion. The geometry of a seal to seal interface is particularly affected by such changes where the stress experienced by each seal at the interface due to changes in operating conditions, such as an increase in temperature, is different. If the stress on one seal increases differently to the stress on the other then it will result in a stress mismatch which will affect the geometry of the seal interface and therefore the sealing properties of the interface will change. This problem has been addressed by providing seals with stiffness and/or hardness within certain limits. The range for the stiffness and/or hardness has been selected to reduce stress changes within the seals and as each seal is formed of a similar stiffness and/or hardness any mismatch in stress experienced by each seal will be small, with correspondingly small changes in the interface geometry between the seals as the temperature of operation changes, providing effective operation across a wide temperature range.

In this regard, an elastomer stiffness that is too low causes the seals to distort excessively when compressed, which leads to an unpredictable interface between the axial and annular seals. An elastomer stiffness that is too high generates large variations in the sealing pressures, causing a T-seal leak when the compressions of the axial and annular seals are not balanced. Using a specific stiffness range ensures that a T-seal functions well over the full design compression ranges for the axial and annular seals.

Conventionally, the stiffness of the sealing materials used for these T-joint seals has not been considered and in particular the longitudinal seals have generally been formed of a softer material than the harder annular seals. It was known that a softer material for the longitudinal seal allowed it to flow towards the annular seal when compressed, with the annular seal able to restrain the end of the longitudinal seal. The inventor discovered that selecting materials with stiffness and/or hardness within a certain range for all of the seals within the set of seals provided effective sealing and enabled new materials to be selected simply on stiffness or hardness values, making the selection and testing of new materials substantially more straightforward. Furthermore, it was found that making the set of seals of materials of similar hardness and/or stiffness allowed the end of the longitudinal seal and the annular seal to substantially retain their form at their intersection providing for a good sealing surface.

In some embodiments, said seals of said set of seals is made of a material having both of:
a hardness between 74-80 on the Shore A hardness scale; and
a stiffness of between 2.4 and 4.2 N/mm per mm length, wherein said stiffness is measured by compressing an O-ring of said material, said O-ring having a cross section diameter of 3.4 mm and an internal diameter of at least 40 mm.

It has been found that both stiffness and hardness are a good predictor of the effectiveness of the seals and thus, the seals may be selected on one of these properties, however in some embodiments both hardness and stiffness may be used to select the materials such that the materials that have properties within the required range for both of these properties may be selected.

It should be noted that stiffness of a component is a function both of its configuration and of the material of which it is formed, and thus, a test to determine the stiffness of the material was devised that was appropriate for the seals in the set. The test involved the axial compression of an O-ring test seal, in which the seal is laid on a flat surface and compressed by a weighted flat surface with increasing weights at room temperature. The deflection vs weight is a measure of the stiffness of the O-ring and was determined for increasing masses in one example from 0.5 to 8 Kg. The stiffness/unit length is then determined from these results the length of the O-ring being its centreline length.

In some test a graph may be formed of force against deflection and the gradient of the slope provides the force/deflection and the result is then divided by the centreline length of the O-ring to get a force/deflection per unit length value.

In summary the stiffness values within the range quoted here are those that are determined using a test material that is in the form of an O ring which has a cross sectional diameter of 3.4 mm+1-10% and an internal diameter that is larger than 40 mm. The axial direction is the direction of an axis through the centre of the circle that the O-ring forms such that in effect the O-ring is a face seal. The deflection which reflects the decrease in the cross-section diameter of the O-ring when compressed is measured and the stiffness is provided as the force required to provide a millimetre deflection for a millimetre length.

The hardness of the material is determined using a standard Shore durometer which is a device for measuring the hardness of a material, typically of polymers, elastomers, and rubbers. Higher numbers on the Shore scale indicate a greater resistance to indentation and thus harder materials. Lower numbers indicate less resistance and softer materials. The shore A hardness number is determined by the penetration of the Durometer indenter into the sample. The international test method designation is ISO 48-4:2018.

In some embodiments, said stiffness of said material is between 2.6 and 3.8 N/mm per mm length.

Although a stiffness of between 2.4 to 4.3 N/mm per mm length has been found to provide an effective seal a stiffness within the range of 2.6 to 3.8 N/mm per mm length is found to be preferable, and even more preferable is a stiffness between 2.8 and 3.4 N/mm per mm length.

Although the seal may be formed of a variety of materials that are able to withstand the required temperatures and have the required elastomeric properties, fluorinated elastomer and nitrides have been found to be effective.

In some embodiments, said material is a material resistant to temperatures in excess of 200° C.

Temperatures or operations of pumps may be in excess of 200° C. and it is at this point that many elastomers may degrade. In effect their effective lifetime decreases significantly as their elastomeric properties degrade at these high temperatures and their sealing effectiveness deteriorates. A material is deemed to be resistant to a particular temperature if the material maintains its elastic properties over several months of operation at that temperature.

Although there are a variety of materials with the required stiffness and hardness that are resistant to these temperatures, in some embodiments said material comprises a perfluoroelastomer.

A perfluoroelastomer has been found to be particularly effective at resisting the high temperatures and provide effective sealing where they have a stiffness and/or a hardness within the required limit.

Fluorinated elastomers contain either a partially or fully fluorinated backbone. If the backbone is fully fluorinated, it is a perfluoroelastomer (FFKM); if it is partially fluorinated, it is a fluoroelastomer (FKM). The polymer backbone is comprised of many repeating monomer units.

Although, the annular seals and longitudinal seals may be formed of different materials provided they are both materials with hardness and/or stiffness within the required limits, in some embodiments, they are formed of the same material.

As noted previously, variations in the stress and compression on each seal causes corresponding changes in their elastomeric properties and in their distortion, thus, forming them of similar materials, particularly where they have a similar sized cross section may improve their performance.

In some embodiments, said longitudinal seal has a thickness of more than 1.5 mm, in particular, said longitudinal seal has a thickness of more than 1.8 mm, preferably more than 2.2 mm.

The properties of the longitudinal seal have also found to be improved if the longitudinal seal is provided with a thickness that it is more of a 1.5 mm and in some cases more than 1.8 mm preferably more than 2.2 mm.

The stresses within the seal are dependent both on the stiffness of the material and on its thickness, and thus, it may be advantageous when selecting a material of a particular stiffness to make the longitudinal seal thicker than it would conventionally be and closer in thickness to the annular seal. In this regard, in some embodiments, the annular seal has a cross section diameter of more than 3 mm, in order to improve sealing quality and reduce compression range, in some embodiments the annular seal has a cross section diameter of between 3.0 and 3.8 mm. Providing the longitudinal seal of a similar thickness allows the stress and compression felt by each seal to be similar and as they are formed of the same material they thus, experience similar changes in their elastomeric properties and in their distortion providing an effective seal. The thickness of the seal is the distance between the two longitudinal surfaces that contact the half shell of the stator when the seal is not compressed.

In some embodiments the cross section of the annular seal and the longitudinal seal differs from each other by less than 50%.

In some embodiments, at least one end of said longitudinal seal configured to abut against said annular seal comprises a flat end surface prior to said seal being compressed.

Although, longitudinal seals with contoured end surfaces adapted for the shape of the annular seal are known, it has been found that a longitudinal seal with a flat surface is particularly effective where materials of the required stiffness are used.

A second aspect provides, a pump assembly comprising a rotor rotatably mounted within a stator, said stator comprising: two half shells defining at least one pumping chamber; and two head plates mounted at either end of said two half shells; and a set of seals according to a first aspect; wherein said longitudinal seals are mounted to seal between longitudinal contact faces of said two half shells and said at least one annular seal is mounted to seal between one of said head plates and an end of said two half shells, said longitudinal seals having end portions that abut against said at least one annular seal.

In some embodiments, said pump assembly comprises a vacuum pump.

The seals are mounted within grooves within the stator components.

A third aspect provides a set of seals for sealing between the stator components of a pump, said stator components comprising two half shells defining at least one pumping chamber and two head plates to be mounted at either end of said two half shells, said set of seals comprising: at least one annular seal for sealing between at least one of said head plates and said two half shells; two longitudinal seals for sealing between longitudinal contact faces of said two half shell stators on either side of said at least one pumping chamber, said longitudinal seals being configured to have end portions that abut against said at least one annular seal when mounted in said pump; wherein each of said seals within said set of seals are made of: FFKM: Trelleborg Isolast® J9577. This material has a density of 2.00+/−0.03 g/cm³, a specific gravity of 2.00, and a hardness of 80 Shore A. It is available from Trelleborg Sealing Solutions UK Ltd (U.K).

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 shows the measured stiffness of a plurality of test materials;

FIG. 2 shows the apparatus used to test the materials;

FIG. 3 schematically shows the stator components to be sealed by a set of seals according to an embodiment; and

FIG. 4 schematically shows the seals within the stator components.

### DETAILED DESCRIPTION

Before discussing the embodiments in any more detail, first an overview will be provided.

Vacuum pumps with a clam-shell construction have T-joints between the stators (clams) and the headplates. These T-joints are sealed with a combination of axial and annular seals, which are compressed. The complex geometry of the T-seal causes the seals to distort when compressed. The main challenge is to keep the seals in contact with the housings and in contact with each other at all possible compressions and all operational temperatures.

Embodiments provide a specific T-seal design which reduces variation in the compression of the axial seals. Many elastomeric materials were evaluated in this T-seal design and the majority failed, a seal was deemed to fail where there is a leak rate above 1×10⁻⁶ mbar·l/s. The failures have either been at room temperature or elevated temperatures such as 180° C. or 220° C.

It was observed that a predictor of failure was the elastomer stiffness and/or hardness of the material and that when it was in a specific range, the T-seals perform well across the required range of operating temperatures. Embodiments provide T-seals formed of a material with this specific range of stiffness and/or hardness.

In this regard, an elastomer stiffness that is too low causes the seals to distort excessively when compressed, which leads to an unpredictable interface between the axial and annular seals. An elastomer stiffness that is too high generates large variations in the sealing pressures, causing a T-seal leak when the compressions of the axial and annular seals are not balanced. Using a specific stiffness range ensures that a T-seal functions well over the full design compression ranges for the axial and annular seals.

It was also found that elastomer hardness properties provided a similar measure of suitability for the seals. However, stiffness provided a better predictor and therefore, a simple O-ring stiffness measurement was devised to identify suitable materials. This test involved the compression of the whole area of the O-ring under several loads.

The measured O-ring cross-section diameter was 3.4 mm+/−10%

The preferred stiffness is 3.12 N/mm per mm of O-ring length, however, materials in the range of 2.4 and 4.2 N/mm per mm length were found to have suitable properties.

A specific material that has this property and have worked well in T-seals is:
FFKM: Trelleborg Isolast® J9577.

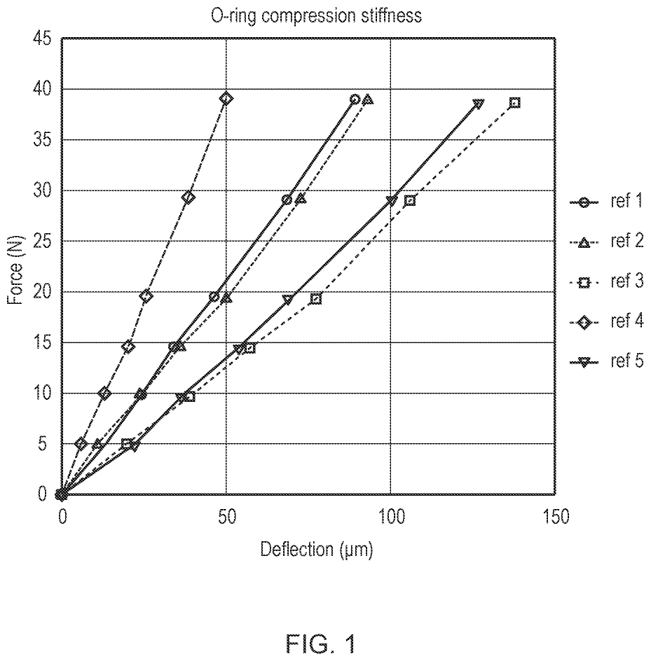

FIG. 1 shows a graph indicating force versus deflection for different materials tested using the O-ring compression test described previously.

In this regard the centreline length of each O-ring tested was between 135 and 145 mm and the determined stiffness for each of ref1 to ref5 was respectively:
3.12, 2.99, 2.00, 2.18, 5.60.

Thus, the materials ref1 and ref2 had the desired stiffness properties, that is a stiffness within the range 2.4 and 4.2 N/mm per mm length. The hardness of these two materials was 75 and 80 on the shore A scale and thus, this too was within the desired range and both values were a predictor of suitability.

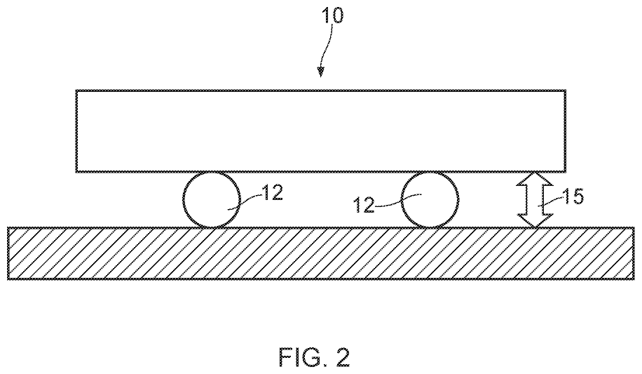

FIG. 2 schematically shows the test apparatus used for determining the compression stiffness of the material. A test O-ring 12 having an internal diameter of more than 40 mm and a cross section diameter of 3.4+/−10% mm was tested for its stiffness by laying it on a flat surface and then placing another flat surface above the O-ring and compressing the O-ring with different loads 10 and measuring the deflection 15. The results were then plotted on a graph such as that shown in FIG. 1 and the stiffness determined therefrom.

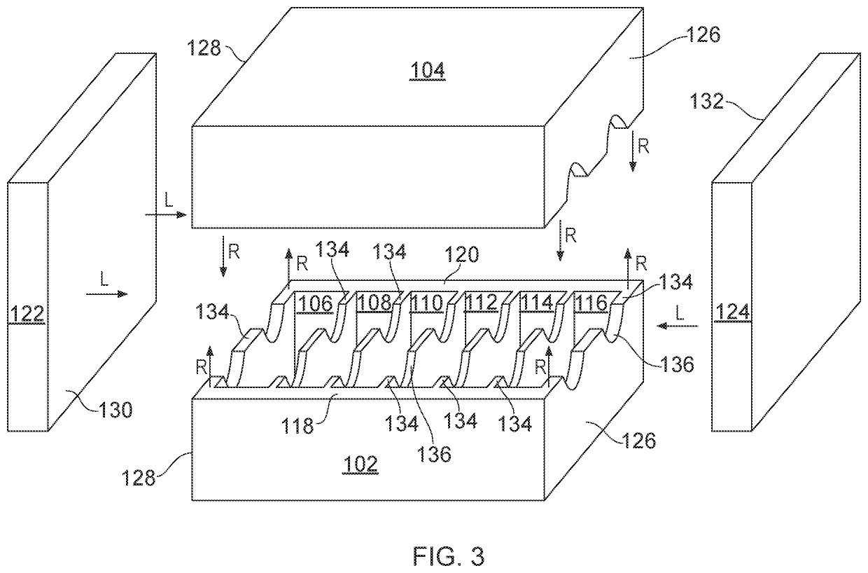

FIG. 3 schematically shows a multiple chamber rotary pump assembly, with two stator half shells and end pieces, which assembly may be advantageously sealed using seals according to embodiments. The pump assembly is formed of two stator half shells 104 and 102 between which a rotor (not shown) is mounted. The two shells are fixed together to form the pump chambers. Each of the chambers 106, 108, 110, 112, 114 & 116 are separated by pump chamber walls 134. End pieces 122 and 124 are mounted on the half shells of the stators to complete the pump assembly. The longitudinal seals are mounted on the stator shell contact surfaces 118, 120, while the annular seals (not shown) are mounted on the mating surfaces of the end pieces 130, 132.

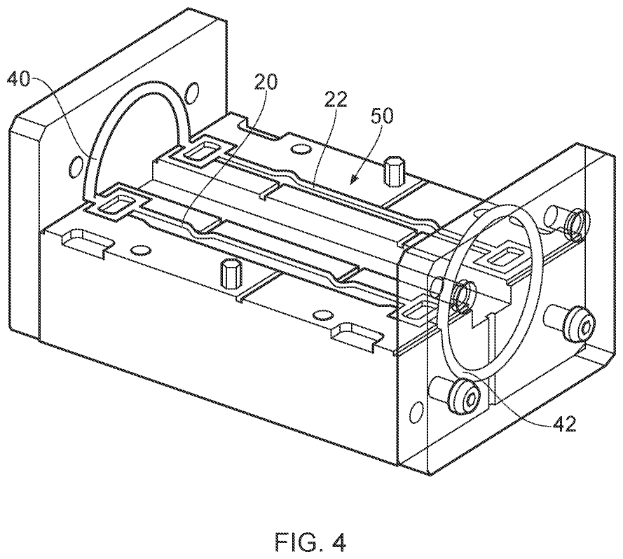

FIG. 4 shows an isometric view of the seals that are arranged between the stator half shells and between the end faces. In this embodiment, there are longitudinal seals 20 and 22 within grooves 50 on either side of the pumping chamber. There are also O-ring seals 40 and 42 also mounted within grooves between the end pieces and the stator half shells.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A set of seals for sealing between the stator components of a pump, said stator components comprising two half shells defining at least one pumping chamber and two head plates to be mounted at either end of said two half shells, said set of seals comprising:
at least one annular seal for sealing between at least one of said head plates and said two half shells;
two longitudinal seals for sealing between longitudinal contact faces of said two half shell stators on either side of said at least one pumping chamber, said longitudinal seals being configured to have end portions that abut against said at least one annular seal when mounted in said pump; wherein
each of said seals within said set of seals are made of a material having at least one of:
a hardness between 73-83, preferably 75-81 on the Shore A hardness scale; and
a stiffness of between 2.4 and 4.2 N/mm per mm length, wherein said stiffness is measured by axially compressing at room temperature an O-ring of said material, said O-ring having a cross section diameter of 3.4 mm and an internal diameter of at least 40 mm.

2. The set of seals according to claim 1, wherein said seals of said set of seals is made of a material having both of:
a hardness between 74-80 on the Shore A hardness scale; and
a stiffness of between 2.4 and 4.2 N/mm per mm length, wherein said stiffness is measured by compressing an O-ring of said material, said O-ring having a cross section diameter of 3.4 mm and a diameter of at least 40 mm.

3. The set of seals according to claim 1, wherein said stiffness of said material is between 2.6 and 3.8 N/mm per mm length.

4. The set of seals according to claim 1, wherein said stiffness of said material is between 2.8 and 3.4 N/mm per mm length.

5. The set of seals according to claim 1, wherein said material is a nitride or a fluorinated elastomer.

6. The set of seals according to claim 1, wherein said material is a material resistant to temperatures in excess of 200° C.

7. The set of seals according to claim 5, wherein said material comprises a perfluoroelastomer

8. The set of seals according to claim 1, wherein said annular seal and said longitudinal seals are formed from a same material.

9. The set of seals according to claim 1, wherein said longitudinal seal has a thickness of more than 1.5 mm.

10. The set of seals according to claim 1, wherein said longitudinal seal has a thickness of more than 1.8 mm, preferably more than 2.2 mm.

11. The set of seals according to claim 1, wherein at least one end of said longitudinal seal configured to abut against said annular seal comprises a flat end surface prior to said seal being compressed.

12. The set of seals according to claim 1, wherein said materials comprises: FFKM: Trelleborg Isolast© J9577

13. A pump assembly comprising a rotor rotatably mounted within a stator, said stator comprising:
two half shells defining at least one pumping chamber; and
two head plates mounted at either end of said two half shells; and
a set of seals according to claim; wherein
said longitudinal seals are mounted to seal between longitudinal contact faces of said two half shells and said at least one annular seal is mounted to seal between one of said head plates and an end of said two half shells, said longitudinal seals having end portions that abut against said at least one annular seal.

14. The pump assembly according to claim 13, wherein said pump assembly comprises a vacuum pump.
